(19) United States
(12) Patent Application Publication
(10) Pub. No.: US 2024/0169993 A1
(43) Pub. Date: May 23, 2024

(54) DUAL-PIPELINE UTTERANCE OUTPUT CONSTRUCT

(71) Applicant: Bank of America Corporation, Charlotte, NC (US)

(72) Inventors: Ramakrishna R. Yannam, The Colony, TX (US); Emad Noorizadeh, Plano, TX (US); Rajan Jhaveri, Plano, TX (US); Jennifer Russell, Dallas, TX (US)

(21) Appl. No.: 17/993,013

(22) Filed: Nov. 23, 2022

(51) Int. Cl. G10L 15/32; H04L 51/02

(52) U.S. Cl. CPC G10L 15/32; H04L 51/02

(57) ABSTRACT

A method for utilizing a dual-pipeline utterance output construct to obtain an output corresponding to an utterance of a user is provided. The method includes receiving the utterance, transmitting the utterance through a non-contextual pipeline to determine a first output prediction, transmitting the utterance through a contextual pipeline to determine a second output prediction, transmitting the first output prediction and the second output prediction to a decider to formulate a final prediction of the user's input, constructing a response to the utterance based on the final prediction; and executing the response to the utterance.

### CROSS-REFERENCE TO RELATED APPLICATION

Co-pending U.S. patent application Ser. No. ______, entitled, “SELECTION SYSTEM FOR CONTEXTUAL PREDICTION PROCESSING VERSUS CLASSICAL PREDICTION PROCESSING”, filed on even date herewith is hereby incorporated by reference herein in its entirety.

### FIELD OF TECHNOLOGY

Aspects of the disclosure relate to language processing. Specifically, the disclosure relates to contextual language processing—i.e., processing language in view of the context in which it is uttered.

### BACKGROUND OF THE DISCLOSURE

An utterance is referred to as contextual when it lacks the ability to convey the user intent absent the context of the conversation.

For example, if a user utters, or otherwise electronically communicates, “show my transaction from Amazon”—this utterance lacks sufficient information to enable a system to form a response. However, if there was a preceding utterance of “$21.64” then it would be desirable if the system can begin to deduce the user intent in the first utterance—i.e., “show my transaction from Amazon” that was valued at $21.64.

It would also be desirable to provide systems and methods that leverage contextual information to mine the intent of a previously indecipherable utterance.

### SUMMARY OF THE DISCLOSURE

A system comprising one or more non-transitory computer-readable media storing computer-executable instructions which, when executed by a processor on a computer system, provides a dual-pipeline utterance output construct to obtain an output corresponding to an utterance of a user. The system may include a receiver for receiving an utterance. The system may include a transmitter for transmitting the utterance through a non-contextual pipeline to determine a first output prediction, for transmitting the utterance through a contextual pipeline to determine a second output prediction and for transmitting the first output prediction and the second output prediction to the processor.

In certain embodiments, the processor is configured to extract, based on the first output prediction and the second output prediction, a final prediction of the user's input.

In some embodiments, the processor is further configured to construct a response to the utterance based on the final prediction. The processor may also be further configured to execute the response to the utterance. Such an execution may include responding by electronic transmission to the user who generated the utterance.

Certain embodiments may include a persistent memory. In such embodiments, the contextual pipeline may be configured to mine the persistent memory to determine the second output prediction. In certain embodiments, the persistent memory may include a plurality of the user's prior conversations. The persistent memory may also store the plurality of the user's prior conversations for future reference.

There are embodiments disclosed herein that utilize a chatbot to implement the above-described system or the system itself may be implemented as a chatbot.

In certain embodiments, the transmitter may be configured to use a topic for the utterance derived from a prior conversation.

The system may also be configured to transmit the utterance through the contextual pipeline to determine the second output prediction only in response to pre-determined criteria. Also—the system may be configured to transmit the utterance through a contextual pipeline to determine a second output prediction only in response to pre-determined criteria. In some embodiments, the pre-determined criteria may be based, at least in part, on a conversation sentiment score and an intent confidence score. For the purposes of this application, an intent confidence score may be understood to reflect a value that reflects the degree of certitude of a predicted output.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram for use in accordance with principles of the disclosure;

FIG. 2 shows another illustrative diagram for use in accordance with principles of the disclosure;

FIG. 3 shows an illustrative flow diagram in accordance with the principles of the disclosure;

FIG. 4 shows another illustrative flow diagram in accordance with the principles of the disclosure;

FIG. 5 shows yet another flow diagram that is based on entity resolution in accordance with the principles of the disclosure;

FIG. 6 shows determining an intent associated with a concatenation of utterances in accordance with the principles of the disclosure;

FIG. 7 shows yet another flow diagram that is based on entity resolution in accordance with the principles of the disclosure;

FIG. 8 shows an exemplary architecture in accordance with the principles of the disclosure; and

FIG. 9 shows a schematic illustration of selectively invoking a contextual text transformation in accordance with the principles of the disclosure.

### DETAILED DESCRIPTION OF THE DISCLOSURE

The embodiments set forth herein are directed to establishing various capabilities. Included in these capabilities are using persistent memory to store and manage prior user conversations. Pursuant thereto, the embodiments can refer back to historical content independent of having to ask for the historical content again. In addition, the embodiments are directed to enabling contextual understanding—i.e., the ability to use information from prior conversations to predict user goals and intents. In this context, understanding refers to correct prediction of user goal and intent.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

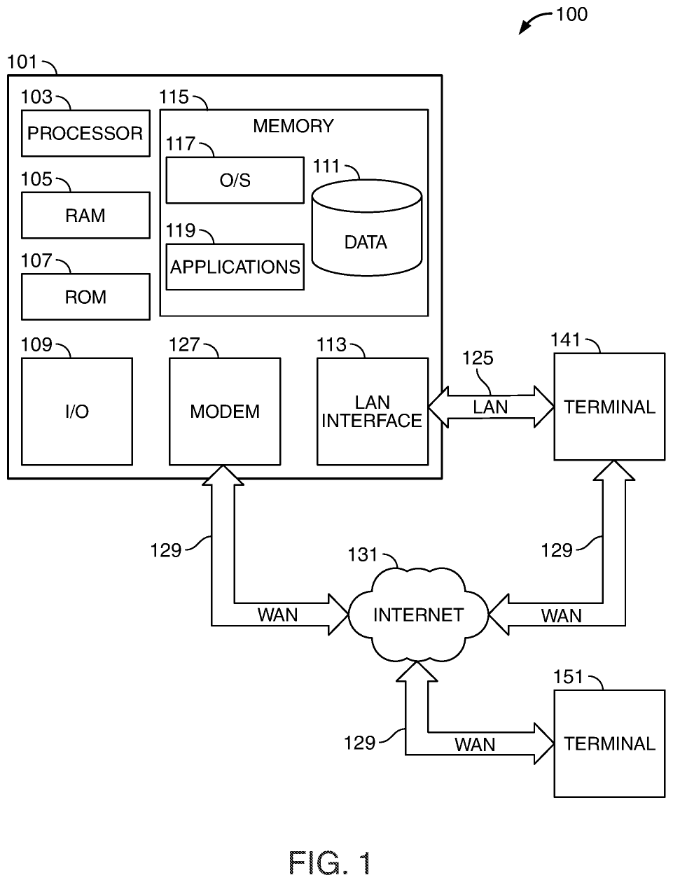

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may have a processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. The processor 103 may also execute all software running on the computer. Other components commonly used for computers, such as EEPROM or Flash memory or any other suitable components, may also be part of the computer 101.

The memory 115 may be comprised of any suitable permanent storage technology—e.g., a hard drive. The memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 is connected to LAN 125 through LAN interface 113 or an adapter. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks. Application program(s) 119 may utilize one or more decisioning processes for the processing of communications involving Artificial Intelligence (AI) as detailed herein.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may utilize the computer-executable instructions executed by a processor. Generally, programs include routines, programs, objects, components, data structures, etc., that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

Any information described above in connection with data 111, and any other suitable information, may be stored in memory 115.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

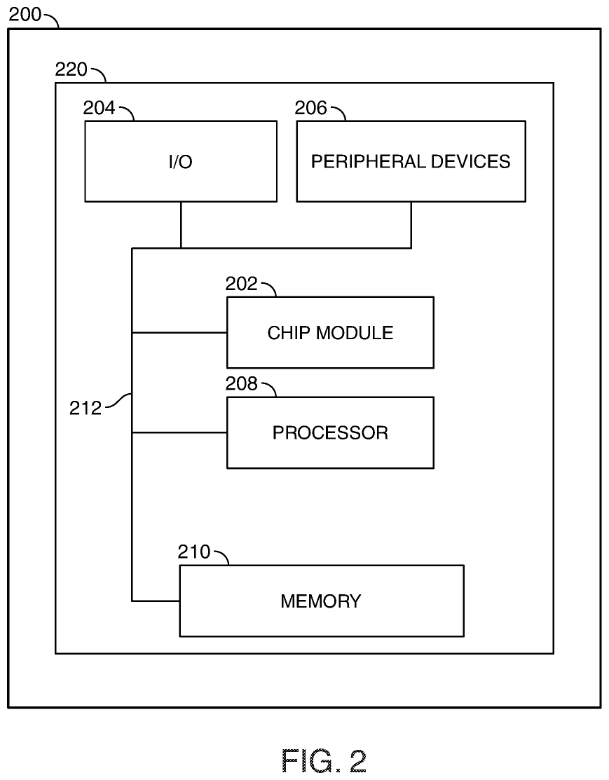

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

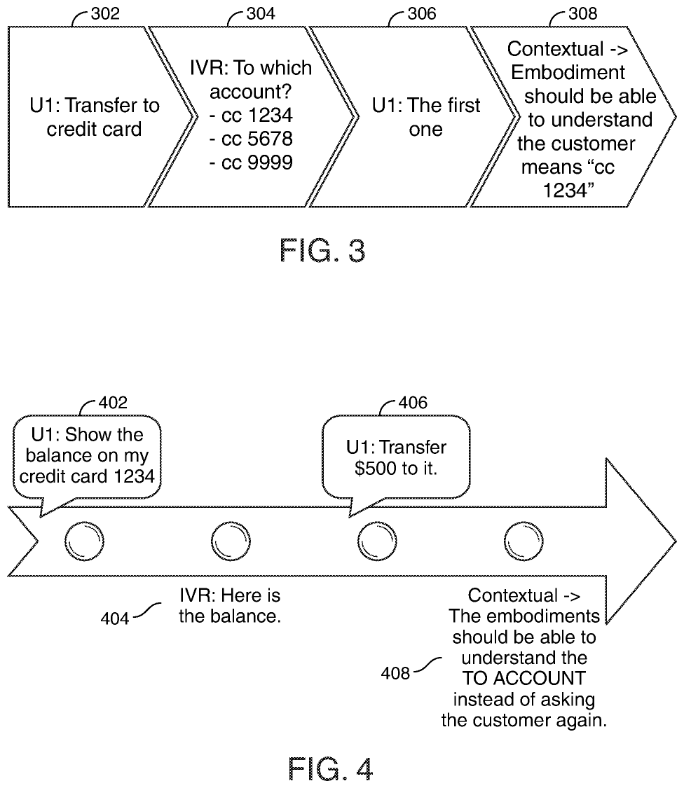

FIG. 3 shows an illustrative flow diagram according to the disclosure. At 301, U1 (Utterance 1) shows, at 302, a request to transfer to credit card.

At 304, an Interactive Voice Response system (IVR) prompts or otherwise queries the user to clarify the credit card account to which the user intends the transfer to be directed.

At 306, U2 indicates that the transfer should be directed to “the first one.”

At 308, the system indicates that the embodiments should be able to leverage the contextual indications to form an understanding that the customer intends the credit card identified as “cc1234.”

The issue with the preceding flow is that context should be able to reveal or otherwise indicate to which credit card U1 referred. Such indication would preferably save multiple steps in the flow—e.g., steps 304 and 306.

FIG. 4 shows another flow diagram according to the disclosure. When a customer or use is explicitly referring to a topic/entity in a previous utterance, a co-reference algorithm according to the disclosure preferably looks to the previous utterance to resolve the co-reference. However, the conventional algorithms typically only look to the IVR response to U1, as is shown in FIG. 4. As such, a co-reference algorithm can be used to again cut resource-consumptive steps from the chain of communication. Furthermore, a co-reference algorithm can reduce errors generated from additional steps in the communication.

At step 402, U1 requests a showing of the balance on credit card 1234. At step 404, IVR responds with credit card balance information. At step 406, U2 requests a “transfer $500 to it.” The “it” in U2 is unclear. However, leveraging the contextual information available in the conversation at 402 and 404, the embodiments should be able to identify the “to it” account, instead of having to request from the user for identification of the account.

Thus, an appropriate co-reference algorithm can save resources and reduce errors in the IVR-user conversations or other communications.

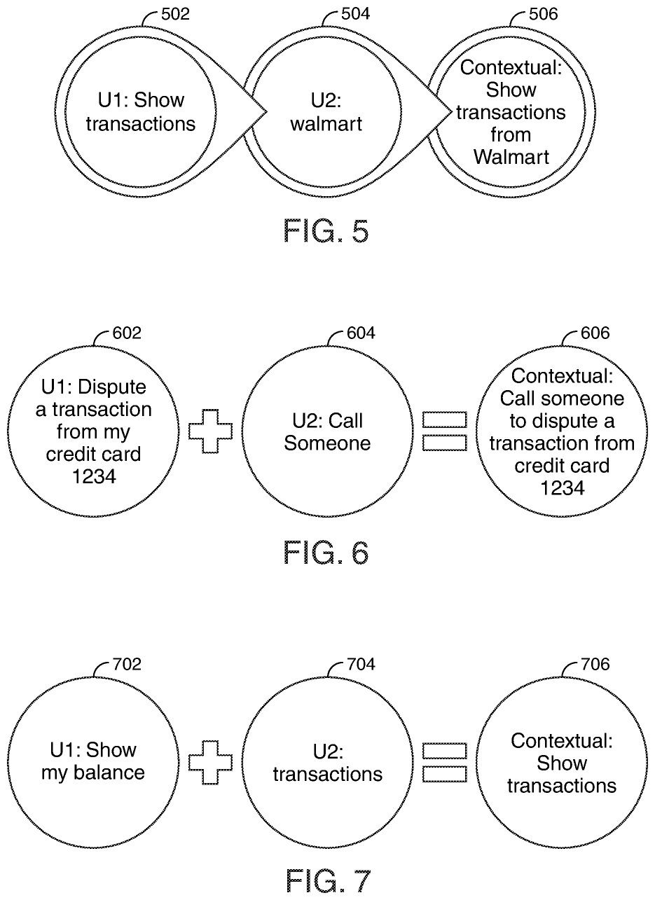

FIG. 5 shows yet another flow diagram that is based on entity resolution relative to the embodiments. Currently, IVR systems, form part of, or otherwise incorporate, a chatbot—i.e., an application used to conduct an on-line chat conversation via text or text-to-speech in lieu of providing direct contact with a live human agent. These IVR systems do not typically or conventionally understand when a customer or other user proactively provides information—e.g., entity information—related to the previous utterance. At 502, U1 requests a showing of transactions. At 504, U2 identifies, as part of the flow of the communication, Walmart as the entity of interest. An appropriate contextual algorithm, the output of which is shown at 506, considers U2 prior to responding to U1 and then responds to U1 with a showing of transactions from Walmart. Such an algorithm may leverage ontological rules as well as other suitable rules to replace/add or otherwise correct entity information in pending or other utterances.

When intent is changed, or a new workflow initiated, embodiments may preferably collect entity information again, or otherwise reset entity information to previous default settings. In addition, embodiments may be configured to review past communications and determine if the entity determinations therein relate to current utterances and communications. This process is referred to herein as memory-based resolution.

FIG. 6 shows determining an intent associated with a concatenation of utterances. The intent determination leverages an appropriate memory-based resolution schema. Specifically, at 602, U1 articulates a dispute regarding a transaction from credit card 1234. U2 expresses that the user is interested in calling someone. At step 606, a suitable contextual algorithm links U1 and U2 to formulate a cohesive intent—i.e., the user has expressed an intent to call someone to dispute a transaction on credit card 1234.

Not always is intent prediction determined just by the information in previous utterances. Rather, when a later-in-time utterance is reviewed in the context of information from a previous utterance, it may be determined that the intent of the later-in-time utterance is different from the information expressed in the previous utterance. However, the information in the previous utterance may be used to inform the intent with respect to the later-in-time utterance. The informing of the intent of the later-in-time utterance preferably enables the embodiments to correctly determine the intent of the later-in-time utterance.

FIG. 7 shows yet another flow diagram. This flow diagram shows intent prediction in the context of a previous utterance. FIG. 7 specifically addresses the embodiments where information from a previous utterance is used to inform the intent of a later-in-time utterance, even though certain information from the previous utterance diverges in intent from information in the later-in-time utterance. At 702, U1 requests the system to show my balance. At 704, U2 indicates that the user is interested in transactions. The embodiments conclude, based on the context of U1 in combination with the information in U2, that the intent of the user in U2, as shown at 706, is the user's expressed desire to show transactions.

Algorithms based on the embodiments, as set forth herein, may operate as follows. In one example, a U1 may articulate, “show my transactions.” A U2 may articulate “Walmart.” Here we expect Artificial Intelligence (AI) which administers IVR rules (referred to herein as a cortex) to understand that when the user says “Walmart” as the second utterance, the user is trying to look for their transactions from Walmart.

In ontology defined in the cortex, there is a relation between show (action) and transactions(topic) and a relation between transactions(topic) and Walmart(MerchantName entity). Thus, the ontology defined in the cortex reuses the underlying concepts from the existing ontology and normalizes the words to a parent class (show internally is a sub-class of class View).

The foregoing approach to reusing underlying concepts from existing ontology and normalizing words to a parent class obtains two major benefits—first, the cortex does not need to add relations for all synonyms of the parent class View with all different topics. Rather, it just builds a relation between View(action) and Transaction(topic) and the other relations (show subclass of View and transactions subclass of Transaction) are able to help the system understand the relation between show and transactions.

The second benefit is that if the token(phrase) is not found in the ontology, cortex may use the existing ontology to look for the synonyms for the parent classes as understood by existing ontology and synonym sets. For example, even if “see” is not added as a subclass of View, cortex concepts retrieve the OntologyClass for see as View and hence any relations that exists for View in the ontology apply to see as action.

In a different example related to a user requesting a stock price, U1 may request, “show stock price of Apple.” U2 may state “Walmart.” The cortex may be expected to understand that when the user says “Walmart” as the second utterance, the user is trying to search for the stock price of Walmart. In such an instance, there is a relation between View (show is a subclass of View) and StockPrice (stock price is a subclass of StockPrice.)

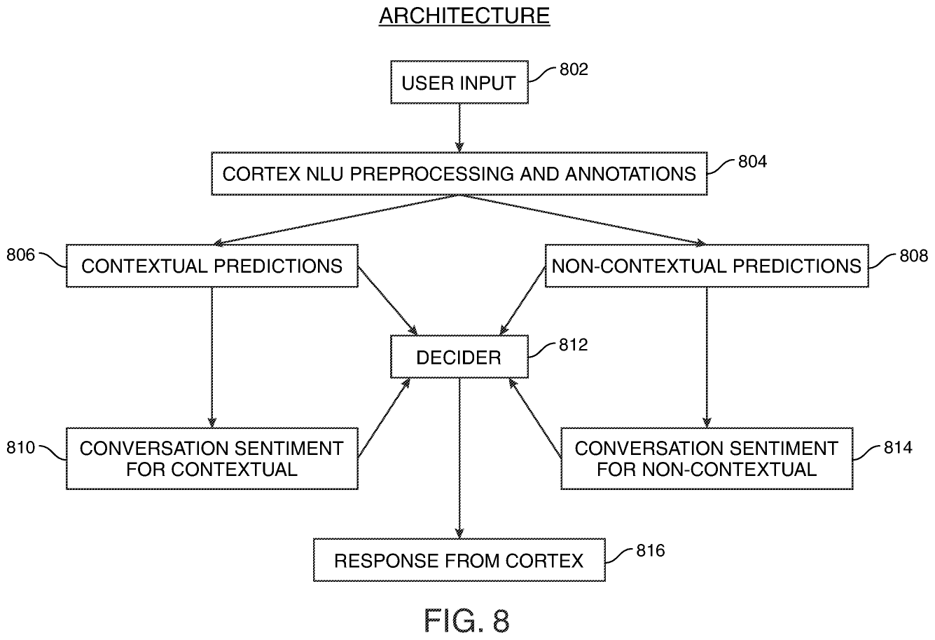

FIG. 8 shows an exemplary architecture according to the embodiments. At 802, a user input (typically an utterance) is received, Thereafter, at 804, the cortex natural language understanding (NLU) is invoked for pre-processing and annotating the utterance.

Following pre-processing and annotation, the utterance may be passed through the contextual pipeline 806 to obtain contextual predictions and through the non-contextual pipeline 808 to obtain conventional predictions. The contextual predictions and the non-contextual predictions may be forward to a decider at 812. It should be noted that, in some embodiments, the utterance may be transmitted to contextual predictions 806

Prior to, or in conjunction with, the contextual predictions being sent to decider 812, the contextual predictions may be reviewed and possibly revised in view of conversation sentiment, as shown at 810. Prior to, or in conjunction with, the non-contextual predictions being sent to decider 812, the non-contextual predictions may be reviewed and possibly revised in view of conversation sentiment, as shown at 814. The terms sentiment determinations as used herein are found and described in more detail in co-pending, commonly-assigned, U.S. patent application Ser. No. 17/539,282, filed on Dec. 1, 2021, entitled, “METHODS AND APPARATUS FOR LEVERAGING SENTIMENT VALUES IN FLAGGING AND/OR REMOVAL OF REAL TIME WORKFLOWS”, which is hereby incorporated by reference herein in its entirety.

Finally, the decider 812, based on all the inputs to it, may formulate a response and trigger the response to be sent from the cortex, as shown at 816.

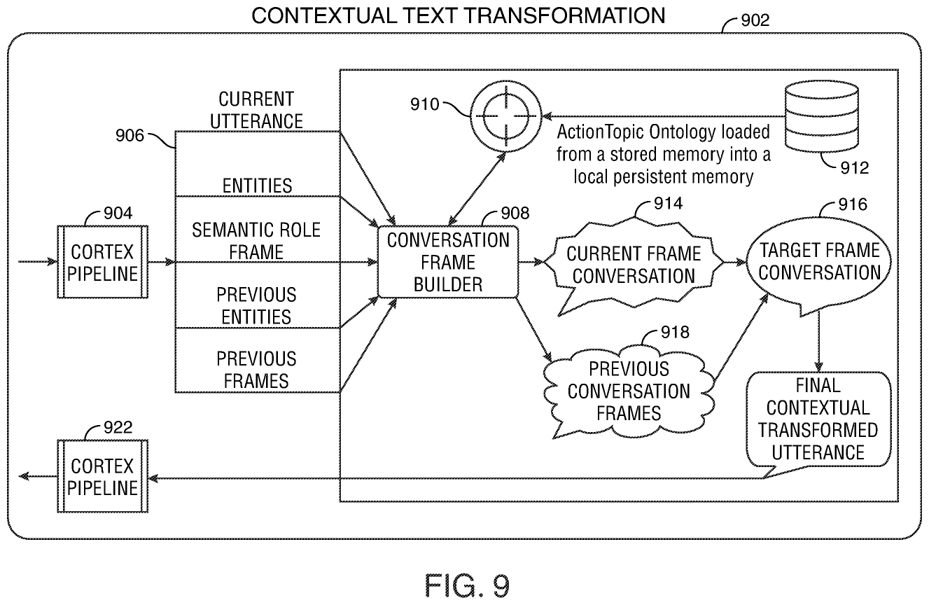

FIG. 9 shows a schematic illustration of selectively invoking a contextual text transformation 902. Contextual text transformation 902 determines when to invoke context to determine intent, or to play a part in determining intent. Preferably, context may be invoked based on specific conditions. For example, in certain circumstances, context may be skipped if the user input comes in the form of a tap of a payment instrument. But in the case of an utterance, the intent prediction from the current utterance and its score may also be used to determine if contextual text transformation 902 should be attempted.

The cortex input pipeline is shown at 904. Pipeline 904 is preferably configured to receive inputs such as a current utterance 906 from a user or from another suitable source. Current utterance 906 may include for example entities, semantic role frames, previously identified entities, previous frames and/or other suitable information. It should be noted that, for the purposes of this application, frames refer to collections of words in a sentence or statement, collections of statements in a conversation, or any other suitable collection of constituents that may be used to determine an intent of a word or statement.

At 908, a selected number of previous utterances and related details are passed to the system at a conversation frame builder 908. Conversation frame builder 908 preferably initiates and assembles a framework for the conversation in which the utterances occur.

At 910, action/topic ontology (which draws from a stored memory into a local persistent memory, as shown at 912) may be used to build a conversation frame for the current utterance and to target a relevant action or topic for the utterance. Following such a build—the current conversation frame 914 may be merged with the information from previous conversation frames 918, to be included in the final target conversation frame 916. Final target conversation frame 916 provides a summary of the conversation at the current point.

At 920, the target conversation frame is validated and leveraged to form the final contextual transformed utterance. The validation preferably serves as a guardrail so that the system does not continue looping over older information even if current utterance does not have any relevant information. Then, based on heuristics, the validation helps generate the final contextual transformed utterance with additional signals, hence giving an enhanced utterance which can be used to understand the user input in the context of the conversation.

In conclusion, contextual text transformation 902 may be used to return a modified contextual utterance if found, as shown at 922.

As such, contextual text transformation 902 has been shown to use an existing model to predict intent and entities based at least in part on the enhanced contextual utterance.

Thus, systems and methods for providing DUAL-PIPELINE UTTERANCE OUTPUT CONSTRUCT. Persons skilled in the art will appreciate that the present invention can be practiced by other than the described embodiments, which are presented for purposes of illustration rather than of limitation. The present invention is limited only by the claims that follow.

What is claimed is:

1. One or more non-transitory computer-readable media storing computer-executable instructions which, when executed by a processor on a computer system, perform a method for utilizing a dual-pipeline utterance output construct to obtain an output corresponding to an utterance of a user, the method comprising:
receiving, using a receiver, the utterance;
transmitting the utterance through a non-contextual pipeline to determine a first output prediction;
transmitting the utterance through a contextual pipeline to determine a second output prediction;
transmitting the first output prediction and the second output prediction to a decider to formulate, based on the first output prediction and the second output prediction, a final prediction of the user's input;
constructing a response to the utterance based on the final prediction; and
executing the response to the utterance.

2. The method of claim 1 wherein the contextual pipeline mines a persistent memory to determine the second output prediction.

3. The method of claim 2 wherein the persistent memory comprises a plurality of the user's prior conversations.

4. The method of claim 2 wherein the persistent memory stores the plurality of the user's prior conversations for future reference.

5. The method of claim 1 wherein the method is implemented using a chatbot.

6. The method of claim 1 wherein the transmitting the utterance through a contextual pipeline to determine the second output prediction comprises using a topic for the utterance derived from a prior conversation.

7. The method of claim 1 wherein the method transmits the utterance through a contextual pipeline to determine the second output prediction only in response to pre-determined criteria.

8. The method of claim 1 wherein the method transmits the utterance through a contextual pipeline to determine a second output prediction only in response to pre-determined criteria, said pre-determined criteria being based, at least in part, on a conversation sentiment score and an intent confidence score.

9. A system comprising one or more non-transitory computer-readable media storing computer-executable instructions which, when executed by a processor on a computer system, provides a dual-pipeline utterance output construct to obtain an output corresponding to an utterance of a user, the system comprising:
a receiver for receiving an utterance;
a transmitter for transmitting the utterance through a non-contextual pipeline to determine a first output prediction, for transmitting the utterance through a contextual pipeline to determine a second output prediction and for transmitting the first output prediction and the second output prediction to the processor;
wherein the processor is configured to extract, based on the first output prediction and the second output prediction, a final prediction of the user's input;
wherein the processor is further configured to construct a response to the utterance based on the final prediction; and
wherein the processor is further configured to execute the response to the utterance.

10. The system of claim 9 further comprising a persistent memory, wherein the contextual pipeline is configured to mine the persistent memory to determine the second output prediction.

11. The system of claim 9 wherein the persistent memory comprises a plurality of the user's prior conversations.

12. The system of claim 9 wherein the persistent memory stores the plurality of the user's prior conversations for future reference.

13. The system of claim 9 wherein the system comprises a chatbot.

14. The system of claim 9 wherein the transmitter is configured to use a topic for the utterance derived from a prior conversation.

15. The system of claim 9 wherein the system is configured to transmit the utterance through the contextual pipeline to determine the second output prediction only in response to pre-determined criteria.

16. The system of claim 9 wherein the system is configured to transmit the utterance through a contextual pipeline to determine a second output prediction only in response to pre-determined criteria, wherein said pre-determined criteria is based, at least in part, on a conversation sentiment score and an intent confidence score.

17. A chatbot system comprising one or more non-transitory computer-readable media storing computer-executable instructions which, when executed by a processor on a computer system, provides a dual-pipeline utterance output construct to obtain an output corresponding to an utterance of a user, the system comprising:
a receiver for receiving an utterance;
a transmitter for transmitting the utterance through a non-contextual pipeline to determine a first output prediction, for transmitting the utterance through a contextual pipeline to determine a second output prediction and for transmitting the first output prediction and the second output prediction to the processor;
wherein the processor is configured to extract, based on the first output prediction and the second output prediction, a final prediction of the user's input, said final prediction being based, at least in part, only in response to pre-determined criteria, wherein said pre-determined criteria is based, at least in part, on a conversation sentiment score associated with a conversation in which the utterance forms a part and an intent confidence score associated with the first output prediction and the second output prediction;
wherein the processor is further configured to construct a response to the utterance based on the final prediction; and
wherein the processor is further configured to execute the response to the utterance.

18. The chatbot system of claim 17 further comprising a persistent memory, wherein the contextual pipeline is configured to mine the persistent memory to determine the second output prediction.

19. The chatbot system of claim 17 wherein the persistent memory comprises a plurality of the user's prior conversations.

20. The chatbot system of claim 17 wherein the persistent memory stores the plurality of the user's prior conversations for future reference.
